(19) United States
(12) Patent Application Publication
(10) Pub. No.: US 2016/0301783 A1
(43) Pub. Date: Oct. 13, 2016

(54) TERMINAL DEVICE

(71) Applicant: Hee-chul JO, Seoul (KR)

(72) Inventor: Hee-Chul JO, Seoul (KR)

(21) Appl. No.: 14/380,479

(22) PCT Filed: Aug. 20, 2014
(86) PCT No.: PCT/KR2014/007741

§ 371 Date: Aug. 22, 2014

(30) Foreign Application Priority Data
Dec. 26, 2013 (KR) 10-2013-0164481

(51) Int. Cl. H04M 1/02; H01R 12/77; H01R 13/631; H01R 13/24

(52) U.S. Cl. CPC H04M 1/0274; H01R 13/24; H01R 12/77; H01R 13/631; H04M 1/0262

(57) ABSTRACT

The present invention relates to a terminal device, the terminal device including a first terminal, and a substrate mounted with a second terminal electrically connected to the first terminal, wherein the first terminal is interposed between mutually contacted first and second outside terminals, and is electrically connected to the first outside terminal or the second outside terminal.

### TECHNICAL FIELD

The teachings in accordance with the exemplary embodiments of this invention relate generally to a terminal device, and more particularly to a terminal device by which a portable multimedia device can be charged.

### BACKGROUND ART

Various smart phone peripheral devices are provided concomitant with fast propagation of smart phones. Hereinafter, smart phones are used to commonly refer to all types of portable multimedia devices. Some of the peripheral devices require an electrical connection with a smart phone or a battery. To this end, a terminal is used provided by a smart phone, which however generates lots of restrictions.

Although Korea Laid-Open Patent No.: 10-2013-0107426 discloses a technology teaching a quick recharge of a smart phone, a terminal provided by the smart phone is used as it is without any change.

### DISCLOSURE OF INVENTION

### Technical Problem

The present invention is directed to solve at least one or more of the aforementioned disadvantages/problems in whole or in part and to provide a terminal device by which a smart phone can be charged.

Technical problems to be solved by the present invention are not restricted to the above-mentioned, and any other technical problems not mentioned so far will be clearly appreciated from the following description by skilled in the art.

### Solution to Problem

An object of the invention is to overcome at least one or more of the above problems and/or disadvantages in whole or in part, and/or provide at least the advantages described hereinafter, and/or make improvements in the prior art. In order to achieve at least the above objects, in whole or in part, and in accordance with the purposes of the invention, as embodied and broadly described, and in one general aspect of the present invention, there is provided a terminal device, the device comprising:

a first terminal; and

a substrate mounted with a second terminal electrically connected to the first terminal, wherein

the first terminal is interposed between mutually contacted first and second outside terminals, and is electrically connected to the first outside terminal or the second outside terminal.

### Advantageous Effects of Invention

The terminal device according to the present invention advantageously includes a first terminal interposed between mutually contacting two outside terminals and a second terminal to enable attainment of separate additional terminal (second terminal) even in a state where there is no terminal useable for charge, whereby an additional terminal can be formed on various multimedia devices including smart phones having mutually contacted two outside terminals, where the additional terminal may be used to variable fields such as connection between a portable multimedia device and an outside battery and connection between a portable multimedia device and an outside communication device.

### BRIEF DESCRIPTION OF DRAWINGS

FIG. 1 is a block diagram illustrating a terminal device according to the present invention.

FIGS. 2 and 3 are cross-sectional views illustrating a terminal device according to the present invention.

FIG. 4 is a schematic view illustrating a multimedia device (10) mounted with a terminal device according to the present invention.

FIG. 5 is a schematic view illustrating a terminal device provided with a guide according to the present invention.

FIG. 6 is a schematic view illustrating a terminal device provided with another guide according to the present invention.

FIG. 7 is a schematic view illustrating an attachment surface of a second guide.

FIG. 8 is a schematic view illustrating another terminal device according to the present invention.

FIGS. 9 and 10 are schematic views illustrating a terminal device according to another exemplary embodiment of the present invention.

### BEST MODE FOR CARRYING OUT THE INVENTION

Now, the present invention will be described in detail with reference to the accompanying drawings. In the drawings, the size and relative sizes of layers, regions and/or other elements may be exaggerated or reduced for clarity.

Accordingly, the meaning of specific terms or words used in the specification and claims should not be limited to the literal or commonly employed sense, but should be construed or may be different in accordance with the intention of a user or an operator and customary usages. Therefore, the definition of the specific terms or words should be based on the contents across the specification.

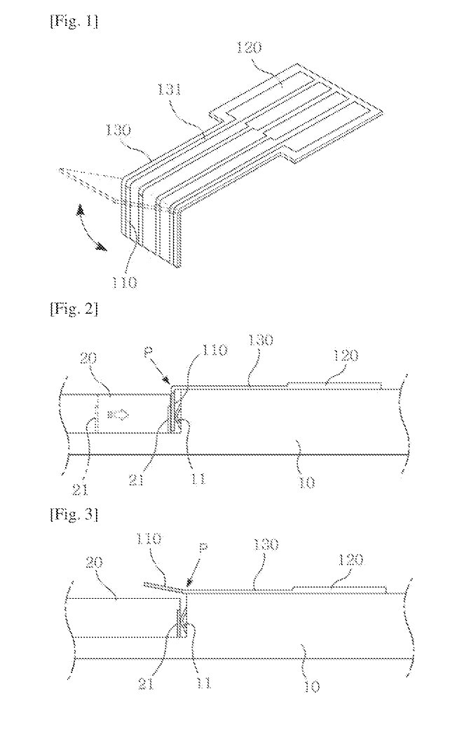

FIG. 1 is a block diagram illustrating a terminal device according to the present invention. The terminal device illustrated in FIG. 1 may include a first terminal (110) and a substrate (130) mounted with a second terminal (120). The first terminal (110) may be interposed between mutually contacted first outside terminal (11) and second outside terminal (21).

The multimedia terminal (10) having portability such as a smart phone is driven by a battery (20) mounted on the multimedia terminal (10). The multimedia device (10) is provided with a first outside terminal (11) as a power input/output terminal in order to receive a power of the battery (10) and to communicate with the battery (20). In response thereto, the battery (20) is provided with a second outside terminal (21) as a power input/output terminal. The first and second outside terminals may be formed in mutually corresponding structure and mutual contact between the first and second outside terminals (11, 21) allows the first and second outside terminals (11, 21) to be electrically connected. When contact between the first and second outside terminals (11, 21) is realized according to prior art, it was impossible to connect other devices to the first outside terminal (11) or to the second outside terminal (21).

However, a first terminal (110) is provided that is interposed between the first outside terminal (11) and the second outside terminal (21) according to the present invention. The first terminal (110) can gain a foothold where at least one of the first outside terminal (11) and the second outside terminal (21) is electrically connected to other devices.

A gap between the first outside terminal (11) and the second outside terminal (21) may be very narrow in a state where the multimedia device (10) is mounted with the battery (20). In order to prevent the battery (20) from being restricted in mounting, it is imperative that the first terminal (110) should be inserted between the first outside terminal (11) and the second outside terminal (21). Thus, the first terminal (110) preferably takes a shape of a thin film. To this end, the first terminal (110) may be a conductive pattern formed on a film type terminal or a non-conductive plate.

Furthermore, the first terminal (110) must be electrically connected the first outside terminal (11) or the second outside terminal (21), because when an electrical connection is interrupted between the first outside terminal (11) and the second outside terminal (21), a power cannot be supplied to the multimedia device. For example, the first terminal (110) may be a conductive pattern formed on a non-conductive plate, or a long plate of conductive material, where one surface may be brought into contact with the first outside terminal (11) and the other surface may be brought into contact with the second outside terminal (21).

Because, the first terminal (110) is interposed between the first outside terminal (11) and the second outside terminal (21), the first terminal (110) is difficult to be directly connected with terminals of other outside devices. Thus, a second terminal (120) may be provided at a position distanced from the first terminal (110). The second terminal (120) may be electrically connected to the first terminal (110). Furthermore, the second terminal (120) may be electrically connected to a terminal of another outside device. The other outside device may be a back cover (12) covering the battery (20) that may be attachable to and/or detachable from the multimedia device (10), for example.

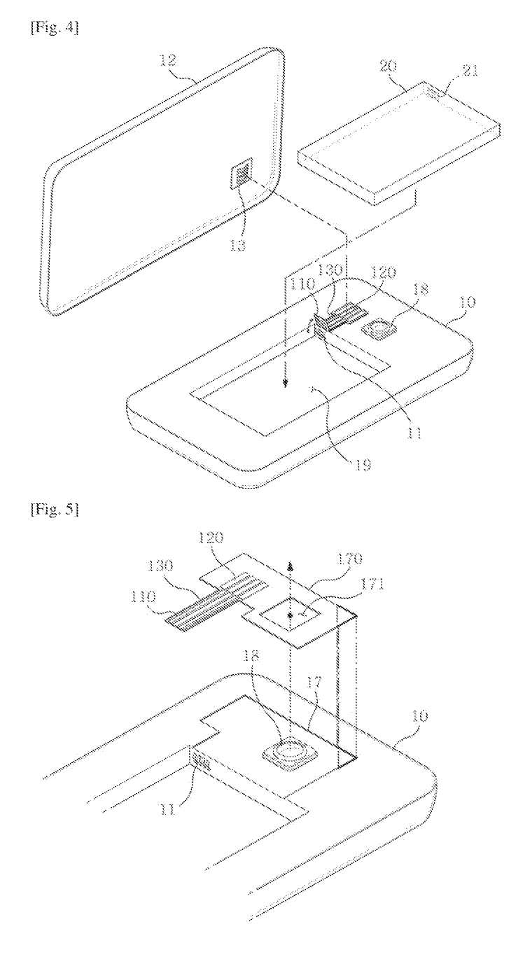

FIG. 4 is a schematic view illustrating a multimedia device (10) mounted with a terminal device according to the present invention.

The second terminal (120) may be brought into contact with a cover terminal (13) provided on the back cover (12). The back cover (12) may be provided with a solar cell generating a power using a solar energy, an auxiliary battery and/or an additional communication device, and a relevant device provided on the back cover (12) may be electrically connected to the battery (20) or to the multimedia device (10) through a cover terminal (13) and the second terminal (120).

The first terminal (110) and the second terminal (120) may be mutually spaced apart at a predetermined distance, whereby a connection pattern (131) may be provided that electrically connects the first terminal (110) to the second terminal (120). At this time, the connection pattern (131) may be mounted on the substrate (130) that connects the first terminal (110) to the second terminal (120). The substrate (130) may be a non-conductive plate or a FPCB (Flexible Printed Circuit Board). Because the substrate (130) is formed with the first and second terminals (110, 120) and the connection pattern (131), a user can attach the entire terminal device of the present invention to the multimedia device (10) by storage or transportation of the substrate (130). Thus, the substrate (130) can enhance the attachability and detachability of the terminal device according to the present invention. As a result, the terminal device according to the present invention may be used to the already used multimedia devices.

Furthermore, the substrate (130) may have a higher strength than that of the connection pattern (131). Thus, when any one position of the first and second terminals (110, 120) is determined, the other position may be guided among the first and second terminals (110, 120) by the substrate (130). For example, when the first terminal (110) is fixed to the first outside terminal (11), the second terminal (120) may be spontaneously guided to a right position opposite to that of the cover terminal (13). Likewise, when the second terminal (120) is fixed to a position corresponding to that of the cover terminal (13), the first terminal (110) may be simultaneously guided to a right position opposite to that of the first terminal (110). To this end, the shape and size of the substrate (13) is preferably set up in consideration of a contact position between the first outside terminal (11) and the cover terminal (13).

Arrangement of any one of the terminals at an initially designed position by the substrate (130) can spontaneously arrange the other terminal to an initially designed position, whereby position alignment convenience can be enhanced. In addition, if the substrate (130) is a film type substrate of flexible material, the installation convenience can be further enhanced. The first terminal may be provided on a distal end of the substrate, or on both surfaces of the substrate. Furthermore, the substrate may be attached to a multimedia device or a battery.

The substrate (130) may take a shape of a plate. When a plate-shaped substrate (130) is placed on an x-y plane and any one terminal is placed on an x-y plane, the other terminal has almost no degree of freedom on x axis and y axis. However, when the substrate (130) is made of flexible material, the other terminal may have a degree of freedom on z axis. Thus, the multimedia device (10) can be gradually contacted to a distal end of the substrate (130) to the other distal end of the substrate (130). When this principle is used, a double sided tape may be used to easily attach the substrate (130) to the multimedia device (10).

Meantime, it may be difficult to insert the first terminal (110) between already contacted first and second outside terminals (11, 21). Thus, it is preferable that one surface of the first terminal (110) be positioned on the first outside terminal (11) before the first and second outside terminals (11, 21) are brought into contact. Under this situation, the second outside terminal (21) attempting to contact the first outside terminal (11) may spontaneously contact the other surface of the first terminal (110). The first terminal (110) may be attachable and detachable between the first outside terminal (11) and the second outside terminal (21), and the second terminal (120) may be secured to the multimedia device (10) provided with the first outside terminal (11).

FIGS. 2 and 3 are cross-sectional views illustrating a terminal device according to the present invention, where FIG. 2 illustrates the first terminal (110) in a state of being inserted (attached state) between the first and second outside terminals (11, 21), and FIG. 3 illustrates the first terminal (110) in a state of being deviated (detached state) from the first and second outside terminals (11, 21).

In order to attach and/or detach the first terminal (110), the substrate (130) may be so formed as to be rotated at a set position P from the first terminal (110) to the second terminal (120). When the second terminal (120) is secured (fixed) to the multimedia device (10), the first terminal (110) rotates about the set position P as an axis. Thus, when the substrate (130) is rotated to allow the first terminal (110) to be brought into contact with the first outside terminal (11), the first terminal (110) is positioned between the first and second outside terminals (11, 21) as illustrated in FIG. 2. When the substrate (130) is rotated to a direction where the first terminal (110) is distanced from the first outside terminal (11), the first terminal (110) is not positioned between the first and second outside terminals (11, 21) as illustrated FIG. 3. Thus, when the set position P, which is a center of rotation, is provided, applicability of the first terminal (110) can be determined in response to a user selection.

A section from the set position P to the second terminal (120) on the substrate (130) and the second terminal (120) may be secured to the multimedia device (10) provided with the first outside terminal (11). Fixation of the substrate (130) or the second terminal (120) and the multimedia device (10) may be used with an adhesive or double-sided tape. Furthermore, the set position P is preferably provided at a distal end of a reception space (19) of the battery (20) provided on the multimedia device (10) or on a floor, whereby the rotation about the set position P is prevented from being interfered by the multimedia device (10).

In the terminal device according to the present invention, a second terminal (120) is additionally provided connectible to the already used outside terminals. The terminal device according to the present invention may be applicable to various outside devices having a terminal mountable with the first terminal (110), in addition to multimedia devices such as smart phones. Meantime, the terminal device according to the present invention may be provided with guide means for convenience of installation, for protection of multimedia device (10) and for reliable connection with outside devices. A plurality of contact pins may be provided as an outside terminal formed on the multimedia device (10). For example, four pieces of contact pins are provided as a first outside terminal (11) as illustrated in FIG. 5. The contact pins may be electrical paths for transmitting mutually different information.

For example, the four contact pins may be respectively a (+) power terminal, a (−) power terminal, a terminal serving as a data path, and a null terminal performing no function. In this case, there may be generated an erroneous operation of the multimedia device (10) or the battery (20), or other outside devices connected to the second terminal (120) may develop an erroneous operation, when each contact pin is short-circuited or connected to other paths. These problems may be generated by contact failure between the first and second outside terminals inserted by the first terminal. In order to prevent these problems, the first terminal (110) must be precisely aligned between the first and second outside terminals (11, 21). That is, the terminal device according to the present invention must be cautiously attached to a right position of the multimedia device (10) so that the first terminal (110) can accurately contact the contact pin formed at the multimedia device (10). That is, an accurate attachment and easy attachment are required.

A guide may be provided as an exemplary embodiment for this purpose. The guide serves to position the first terminal (110) at an easy and accurate position. The guide may guide the position of the first terminal (110) or the position of the second terminal (120).

FIG. 5 is a schematic view illustrating a terminal device provided with a guide according to the present invention, where the terminal device may include a guide to prevent a contact failure between the first and second outside terminals (11, 21) by the first terminal (110). The guide may guide an installation position of the second terminal (120). When the installation position of the second terminal (120) is guided, an installation position of the first terminal (110) may be determined by the substrate (130).

The guide may include a first guide configured to guide a fixed position of the second terminal (120) on the multimedia device (10), where the first guide may include an extension unit (170) configured to be extended from the substrate (130) to an identification line (17) of the multimedia device (10). The extension unit (170)

may be integrally formed with the second terminal (120) or with the substrate (130) provided with the second terminal (120). The identification line (17) may be a line or a thing identifiable by a user such as a line, a lug, a groove or an edge on the multimedia device (10) that is formed on a surface fixed by the second terminal (120). A line (17) formed in the shape of an ‘L’ on a surface fixed by the second terminal (120) is indicated as the identification line (17) in FIG. 5. The extension unit (17) may take a shape corresponding to that of the identification line (17) of ‘L’. As a result, the second terminal (120) can be accurately installed by attaching the second terminal (120) to the multimedia device (10) when a user aligns the extension unit (170) to the identification line ‘L’. That is, the extension unit (170) can align the second terminal (120) using the identification line (L, 17) provided on the multimedia device (10).

As another identification unit, a camera module (18) is disclosed that is protruded from a surface on which the second terminal (120) is secured. The extension unit (170) may be provided with identification unit (171) inserted into the camera module (18). The identification unit (171) may be a groove or a hole inserted by the camera module (18). As a result, a user, while the identification unit (171) is inserted into the camera module (18), can accurately install the second terminal (120) by attaching the second terminal (120) to the multimedia device (10). Thus, the first guide enables the terminal device to be attached to the multimedia device by simply and conveniently aligning the terminal device.

FIG. 6 is a schematic view illustrating a terminal device provided with another guide according to the present invention, where the guide of FIG. 6 may include a second guide (150) configured to guide an installation (mounting) position of the first terminal on the multimedia device. The second guide (150) may be provided with a first outside terminal (11) or an insertion unit (151) inserted into the second outside terminal (21). The insertion unit (151) may be a groove or a hole so formed as to match a size and a gap of a contact pin forming the first outside terminal (11). The second guide (150) may be attached to the first terminal (110) or the substrate (130), and may be removed from the first terminal (110) or from the substrate (130) after guide of the installation position.

The second guide (150) may be a plate-shaped rear sheet attached to a rear surface of the substrate (130). The rear sheet may guide a position on which the terminal device according to the present invention is attached to the multimedia device, and the rear sheet may be extended from the substrate (130) to a position of the first terminal (110). The insertion unit (151) may be formed at an area opposite to the first terminal (110) on the rear sheet, whereby the insertion unit (151) separated from the first terminal (110) can be inserted into the first outside terminal (11).

The first outside terminal (11) may have a protruding elastic body like a contact pin for reliable contact between the first outside terminal (11) and the second outside terminal (12). The contact pin may be protruded from a device body to contact the second outside terminal. The contact pin protruded from the multimedia device body may be easily inserted into the insertion unit (151). While the contact pin is inserted into the insertion unit (151), the substrate (130) can be pulled from the first terminal (110) to a direction facing the second terminal (120), and the substrate (130) can be attached to the multimedia device (10) provided at the first outside terminal (11). Furthermore, the rear sheet can be removed from the substrate (130). When the rears sheet is removed, the first terminal (110) can be aligned on a position of the first outside terminal (11).

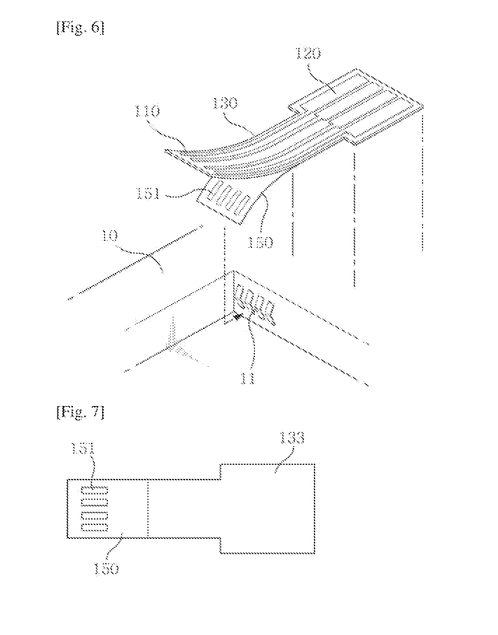

That is, the substrate (130) can be attached to the multimedia device, and an attachment surface of the substrate (130) may be attached by the second guide (150) that is inserted into the contact pin. At this time, the second guide (150) may be removed from the substrate (130) after the substrate (130) is attached to the multimedia device (10). The attachment surface of the substrate may be as shown in FIG. 7 for performing a reliable function of the second guide (150).

FIG. 7 is a schematic view illustrating an attachment surface of a second guide.

Referring to FIG. 7, the second guide (150) may be attached to a first terminal (110) side from the attachment surface of the substrate (130) attached to the multimedia device (10), and an adhesive (133) may be coated on a second terminal (120) side. As a result of this configuration, the substrate (130) can be attached to the multimedia device (10) while the insertion unit (151) of the second guide (150) is inserted into the first outside terminal (110). Furthermore, the second guide (150) can be removed from the substrate (130) after the substrate (130) is attached to the multimedia device (10).

Meantime, a distal end of the rear sheet may be provided with a stopper to be hitched at a sill of the reception space (19) of the battery (20). The stopper may be extended to a second direction facing a floor of the reception space (19) so as to be hitched at the sill of the reception space (19) when the substrate (130) is extended to a first direction. The stopper may be provided on the aforementioned set position P. In this case, when the stopper is pulled until hitched at the sill of the reception space (19), the first terminal can be placed at an appropriate position to the first direction. Furthermore, when a hole or a groove is formed at the stopper on a surface facing the first outside terminal (11), a horizontal position of the stopper can be adequately maintained, whereby the first terminal (110) can be also rightly placed on the first outside terminal.

FIG. 8 is a schematic view illustrating another terminal device according to the present invention.

Referring to FIG. 8, the first outside terminal (11) may be provided with a plurality of contact pins that protrudes from the multimedia device body to contact the second outside terminal (12). At this time, the substrate (130) may be provided with a guide groove (135) inserted by some of the plurality of contact pins. For example, when a solar panel or an auxiliary battery is connected to the first terminal (110), there would be no need of using a contact pin that is used as a data path. Alternatively, when means for communicating with the multimedia device (10) through the first terminal (110) is provided, there would be no need of using a contact pin as a power terminal.

The substrate (130) may be provided with an inclusion unit (139) interposed between the first and second outside terminals (11, 12). If only a contact pin as a power terminal is used, the inclusion unit (139) may be provided with a guide groove (135) that is to be inserted into at least one of the terminals except for the power terminal. Furthermore, the inclusion unit (139) may be provided with a first terminal (110) that contacts the power terminal.

Referring to FIG. 8 again, the contact pins \textcircled{1}, \textcircled{2}, \textcircled{3}, \textcircled{4} may be formed on the multimedia device as first outside terminals (11). Among the contact pins of \textcircled{1}, \textcircled{2}, \textcircled{3}, \textcircled{4}, when the contact pins \textcircled{1}, \textcircled{2} are used as power terminals, the guide groove (135) on the inclusion unit (139) may be provided at positions corresponding to those of the contact pins \textcircled{2}, \textcircled{4} having nothing to do with the power terminal. Furthermore, the first terminal (110) may be formed at positions corresponding to those of contact pins \textcircled{1}, \textcircled{3} on the inclusion unit (139).

Thus, when the substrate (130) is attached to the multimedia device (10) to allow the contact pins \textcircled{2}, \textcircled{4} to be inserted into the guide groove (135), the contact pins \textcircled{1}, \textcircled{3} can be spontaneously contacted to the first terminal (110). Furthermore, the substrate (130) can be formed with the second guide (150) free from separately using the aforementioned rear sheet. The first outside terminal (11) may be provided at the reception space (19) formed at the multimedia device (10), that is, at a groove lateral wall of the battery groove. At this time, the inclusion unit (139) may be extended to a corner ?? of the groove lateral wall.

When an extension unit (137) extended to a corner ?? is formed at the inclusion unit (139), an interposed position of the inclusion unit (139) can be aligned by closely mounting the extension unit (137) to the corner of the groove lateral wall. When the first terminal (110) is provided at the inclusion unit (139), the first terminal (110) can be also spontaneously aligned on the first outside terminal (11) in response to the alignment of the inclusion unit (139).

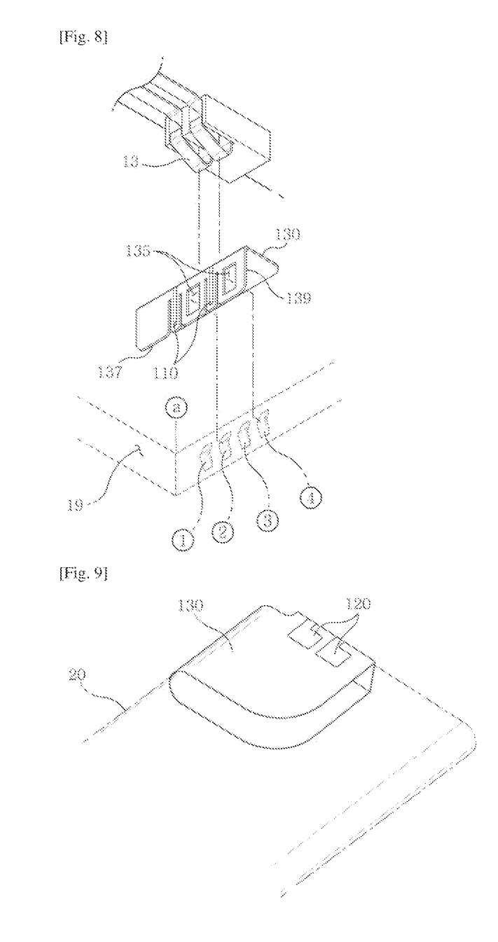

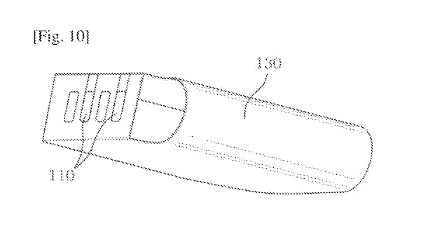

FIGS. 9 and 10 are schematic views illustrating a terminal device according to another exemplary embodiment of the present invention.

Referring to FIGS. 9 and 10, the terminal device according to another exemplary embodiment of the present invention includes a first terminal (110) interposed between a first outside terminal (11) and a second outside terminal (12), and a second terminal (120) connected to a cover terminal (13).

The first and second terminals (110, 120) are electrically connected, and respectively positioned at one side and the other side of the substrate (130). The substrate (130) is a non-conductive film and takes a shape of being inserted to at least a part of the battery (20).

The thickness of the substrate (130) is substantially equal to a gap between a battery reception space (19) formed at the multimedia device and the battery (20) attached thereto and detached therefrom, or the thickness of the substrate (130) is preferably less than 0.3 mm.

The first or second terminal (110, 120) which is of a conductive pattern formed on the thin substrate thus configured is preferably formed with an area sufficient enough not to be separated from the substrate (130), and the shape of the substrate (130) preferably covers a lateral side of the battery (20) or covers at least a part of the battery (20).

### INDUSTRIAL APPLICABILITY

The present invention has an industrial applicability in that the terminal device according to the present invention includes a first terminal interposed between mutually contacting two outside terminals and a second terminal to enable attainment of separate additional terminal (second terminal) even in a state where there is no terminal useable for charge, whereby an additional terminal can be formed on various multimedia devices including smart phones having mutually contacted two outside terminals, where the additional terminal may be used to variable fields such as connection between a portable multimedia device and an outside battery and connection between a portable multimedia device and an outside communication device.

The previous description of the present invention is provided to enable any person skilled in the art to make or use the invention. Various modifications to the invention will be readily apparent to those skilled in the art, and the generic principles defined herein may be applied to other variations without departing from the spirit or scope of the invention. Thus, the invention is not intended to limit the examples described herein, but is to be accorded the widest scope consistent with the principles and novel features disclosed herein.

1. A terminal device, the device comprising:
a first terminal; and
a substrate mounted with a second terminal electrically connected to the first terminal, wherein
the first terminal is interposed between mutually contacted first and second outside terminals, and is electrically connected to the first outside terminal or the second outside terminal.

2. The terminal device of claim 1, wherein the substrate is a film type substrate of flexible material or a non-conductive plate, and the first terminal is provided on a distal end of the substrate or on both surfaces of the substrate.

3. The terminal device of claim 1, wherein the first outside terminal is provided on a multimedia device driven by a battery, the second outside terminal is provided on the battery, and the substrate is attached to the multimedia device or to the battery.

4. The terminal device of claim 1, wherein the first outside terminal is provided on the multimedia device driven by the battery, the second outside terminal is provided on the battery, the multimedia device is provided with a back cover covering the battery, and the second terminal is brought into contact with a cover terminal provided on the back cover.

5. The terminal device of claim 1, further comprising a guide unit configured to prevent a contact failure between the first outside terminal and the second outside terminal by the first terminal, wherein the guide unit guides a mounted position of the second terminal, and a mounted position of the first terminal is determined by the substrate when the mounted position of the second terminal is guided.

6. The terminal device of claim 1, wherein the first outside terminal is provided on the multimedia device, the second terminal is secured to the multimedia device, and the terminal device further comprises a first guide configured to guide a fixed position of the second terminal on the multimedia device, wherein the first guide includes an extension unit configured to be extended from the substrate to an identification line.

7. The terminal device of claim 1, wherein the first outside terminal is provided on the multimedia device driven by the battery, the second outside terminal is provided on the battery, and wherein the terminal device further comprises a second guide configured to guide an interposed position of the first terminal on the multimedia device, and wherein the second guide is inserted into the first outside terminal or into the second outside terminal.

8. The terminal device of claim 1, wherein the first outside terminal is provided on the multimedia device driven by the battery, the first outside terminal is provided with a contact pin protruded from a multimedia device body to contact the second outside terminal, the substrate is attached to the multimedia device, the substrate is attached at an attachment surface with a second guide inserted into the contact pin, and the second guide is removed from the substrate after the substrate is attached to the multimedia device.

9. The terminal device of claim 1, wherein the first outside terminal is provided on the multimedia device driven by the battery, the first outside terminal is provided with a plurality contact pins protruded from a multimedia device body to contact the second outside terminal, the substrate is provided with a guide groove inserted by at least one of the plurality of contact pins.

10. The terminal device of claim 1, wherein the first outside terminal is provided with a plurality of terminals included with a power terminal, the substrate includes an inclusion unit interposed between the first outside terminal and the second outside terminal, and the inclusion unit includes a guide groove inserted by at least one of the terminals excluding the power terminal, and the first terminal contacting the power terminal.

11. The terminal device of claim 1, wherein the first outside terminal is provided on a groove lateral wall of a battery groove formed at the multimedia device, the substrate includes an inclusion unit interposed between the first outside terminal and the second outside terminal, the inclusion unit is extended to a corner or a floor of the groove lateral wall, and an interposed position of the inclusion unit is aligned when the inclusion unit comes close to the corner or the floor of the groove lateral wall.

12. The terminal device of claim 1, wherein the first and second terminals (110, 120) are electrically connected, and the first and second terminals (110, 120) are respectively positioned at one side and the other side of the substrate (130), and the substrate (130) is a non-conductive film, and the substrate (130) covers a lateral side of a battery (20) driving multimedia device or is inserted at least a part of the battery (20), and the thickness of the substrate (130) is substantially equal to a gap between a battery reception space (19) formed at the multimedia device and the battery (20) attached thereto and detached therefrom or the thickness of the substrate (130) is preferably less than 0.3 mm.
